(19) United States
(12) Patent Application Publication
(10) Pub. No.: US 2010/0085745 A1
(43) Pub. Date: Apr. 8, 2010

(54) PORTABLE STORAGE CONTAINER WITH LAMP ASSEMBLY

(76) Inventors: Keith Kristiansen, Stratford, CT (US); Thomas C. VanDyk, Ramsey, NJ (US); David A. Demar, Tenafly, NJ (US); Roland Charriez, Mohegan Lake, NY (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/573,420

(22) Filed: Oct. 5, 2009

Related U.S. Application Data
(60) Provisional application No. 61/103,408, filed on Oct. 7, 2008.

(51) Int. Cl. F21V 21/00

(52) U.S. Cl. 362/217.1

(57) ABSTRACT

A portable storage container with lamp assembly provides for the storage of various items and includes a useful source of light that is conveniently and efficiently stored within the container's enclosure when not in use, such as when the container is being carried from one location to another location. The storage container includes a storage compartment, handle and a lamp housing that is connected to the upper surface of the container. When stowed, the lamp housing sits flush with the container's upper surface. The container may include other features including a power outlet as a source of power to electrical devices, a power cord, a rechargeable battery and conveniently placed storage trays.

### REFERENCE TO RELATED APPLICATION

This application claims priority to U.S. Provisional Patent Application No. 61/103,408, filed on Oct. 7, 2008. The disclosure of U.S. Provisional Patent Application No. 61/103,408 is incorporated herein by reference.

### BACKGROUND OF THE INVENTION

1. Field of the Invention

This invention relates to a portable storage container including an adjustable light assembly and a power outlet.

2. Description of the Related Art

It is often convenient and thus desirable to have the work area surrounding a portable container well lit and to have a power outlet to provide power to tools used within the lit work area.

### OBJECTS AND SUMMARY OF THE INVENTION

In view of the foregoing, it is an object of the present invention to provide a portable storage container which provides for a well lit work area adjacent to the container.

It is another object of the present invention to provide a means to power tools used within the work area adjacent to the work area.

These and other objects are achieved by a portable storage container, comprising: an enclosure having front and rear surfaces, a pair of side surfaces, and upper and lower surfaces, a storage compartment within the enclosure, a lamp assembly extending from the upper surface of the enclosure, the lamp assembly having an articulating arm pivotally coupled to the upper surface of the enclosure and an elongated lamp housing extending from the articulating arm, the lamp assembly movable between a stowed position and an extended position, the articulating arm and the lamp housing disposed respectively in first and second recesses in the upper surface of the enclosure when the lamp assembly is in the stowed position, a bulb disposed within the lamp housing, and a handle pivotally connected to the upper surface of the enclosure.

As an aspect of the present invention, the first and second recesses in the upper surface of the enclosure are perpendicular to one another, the first recess extends along a center of the upper surface, and the second recess extends along a front edge of the upper surface.

As a further aspect of the present invention, the articulating arm includes two individual arms pivotally connected to one another, the end of one arm being pivotally connected to the upper surface of the enclosure and the end of the other arm being connected to the lamp housing.

As a feature of this aspect, both the first and second arms are disposed on top of one another and within the first recess in the upper surface of the enclosure when the lamp assembly is in the stowed position.

As a further aspect of the present invention, both the articulating arm and the lamp housing sit flush with the upper surface of the enclosure when the lamp assembly is in the stowed position.

As an additional aspect of the present invention, the handle is movable between a stowed position and an extended position, the handle is disposed in a third recess in the upper surface of the enclosure when the handle is in the stowed position, and the third recess in the upper surface is separate from the first and second recesses.

As feature of this aspect, the third recess in the upper surface of the enclosure is disposed around a first end of the first recess, and the second recess is disposed at a second end of the first recess.

As a further aspect of the present invention, the portable storage container includes a power cord electrically connected to the lamp assembly and the power cord is disposed within a recess in the back surface of the enclosure when the power cord is in a stowed position.

As a feature of this aspect, a power outlet is disposed in one of the surfaces of the enclosure and the power outlet is electrically coupled to the power cord and adapted to supply power to an electrical device plugged into the power outlet when the power cord is coupled to an external source of power.

As a further feature of this aspect, a rechargeable battery is disposed within the enclosure and is electrically coupled to the power cord and adapted to provide a source of power to the bulb at least when the power cord is not coupled to an external source of power.

As an additional aspect of the present invention, the portable storage container further includes a pair of open trays within the upper surface of the enclosure and disposed on opposite sides of the first recess in the upper surface of the enclosure.

As another aspect of the present invention, the storage compartment includes at least one slidable drawer.

As yet a further aspect of the present invention, the lamp housing extends along substantially an entire length of the upper surface of the enclosure.

As an additional aspect of the present invention, the bulb disposed within the lamp housing is a longitudinally extending fluorescent type bulb.

Various other objects, advantages, features and aspects of the present invention will become readily apparent to those of ordinary skill in the art from the following detailed description of the invention.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a schematic illustration of the portable storage container of the present invention, with the handle, the articulating arm and the lamp assembly shown in a stowed position;

FIG. 2 is another schematic illustration of the portable storage container, with the articulating arm and the lamp assembly shown in an extended position; and

FIG. 3 is a schematic illustration of a rear view of the portable storage of the present invention.

### DETAILED DESCRIPTION OF THE PREFERRED EMBODIMENTS

In accordance with the embodiments of the invention disclosed hereinafter, and as further described below, the portable storage container includes an adjustable lamp assembly for illuminating an area surrounding the container. The lamp assembly is adjustable between a stowed, recessed position when the container needs to be carried and a deployed, upright position to shine light about an area surrounding the container. The lamp may include either an incandescent bulb, a fluorescent bulb or other suitable bulb.

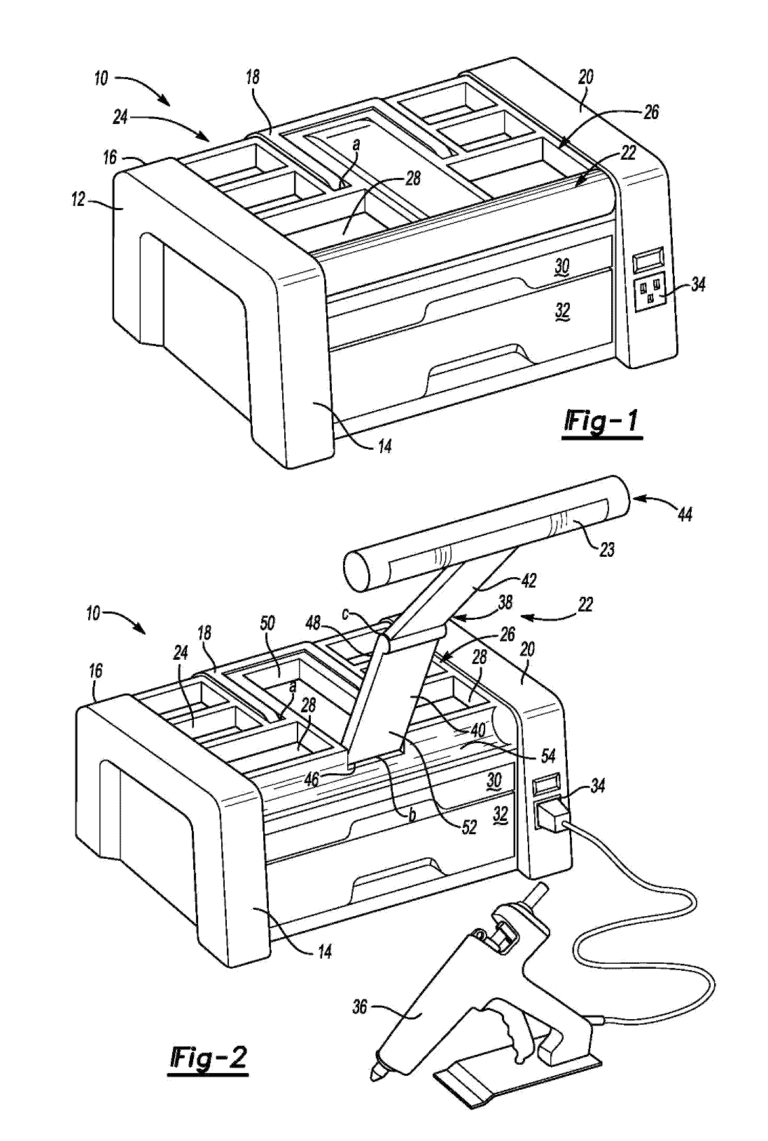

Referring to the accompanying FIGS. 1 and 2, there is shown a portable storage container 10 according to a first embodiment of the present invention. The container 10 includes an exterior casing 12 (also called “enclosure”). The casing 12 is preferably manufactured in a variety of colors including, for example, yellow, red, green, blue and black (and combinations thereof), to appeal to both male and female hobbyists and sportsmen, as well as others who may find the container 10 useful. Further, the casing 12 is manufactured preferably from suitably strong plastic or aluminum or other comparable lightweight material to reduce the overall weight of the container 10, thereby making it easier to carry from one location to another. Since materials suitable for the manufacture of portable storage containers, such as tool boxes, are well known, further description thereof is omitted from the description except where necessary for an understanding of the present invention.

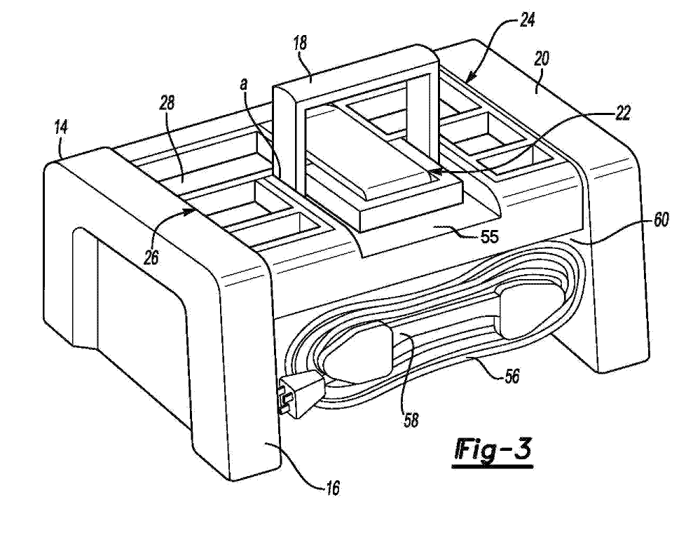

The exterior 12 defines a front side 14 and a backside 16 of the container 10. A handle 18 for carrying the container 10 is provided between the front side 14 and the backside 16 and is pivotally connected to the exterior at “a” on the upper surface 20 of the container 10. The handle 18 folds into a slot (or “recess”) 55 in the upper surface when in the recessed position (slot 55 shown in FIG. 3). A lamp assembly 22, including a compact fluorescent lamp (“CFL”) 23 (or other suitable type bulb or bulbs) is further provided, adjacent the handle 18, for illuminating an area surrounding the container 10. As shown in FIG. 1, both the handle 18 and the lamp assembly 22 are shown in their recessed positions.

The upper surface 20 of the container 10 further includes beds 24 and 26 of open trays 28 which are positioned on both sides of the handle 18 and the lamp assembly 22. Beneath the trays 28, there are provided a pair of transparent plastic drawers 30 and 32 for securely containing items carried by the container 10. Alternatively, the drawers are not transparent.

The container 10 further provides a source of electricity through its electrical outlet 34 (also called “power outlet”). Electrical outlet 34 is located on the front side 14 of the container 10. The outlet 34 is provided for receipt of a plug associated with a tool, such as a glue gun 36 or other device, which may (or may not) be used in accomplishing a given task at the location to which the container 10 is brought.

With specific reference to FIG. 2, the lamp assembly 22 is shown in its deployed (or “extended”) position for illuminating an area surrounding the container 10. As shown, the lamp assembly 22 includes an articulating arm 38 that includes a first member 40 (also called herein “first arm” or “first arm member”) and a second member 42 (also called herein “second arm” or “second arm member”) for enabling the lamp assembly 22 to move between its recessed and deployed positions, and an elongated lamp housing 44 and included lamp 23. Preferably, lamp housing 44 extends along the entire length or nearly (or substantially) the entire length of the front of the container, between the two sides of the container, as shown. One end 46 of the first arm member 40 is hingedly connected to the container at “b.” First arm member 40 is connected at its other end 48 with the second arm member 42 at “c,” whereby the latter is pivotal thereabout.

In its recessed position, as shown in FIG. 1, the first arm member 40 is pivoted from its deployed position, as shown in FIG. 2, toward the backside 16 of the container 10 and is folded into a slot 50 (also called herein “first recess”) which is centered between constituent portions of the handle 18. When achieving this position, the second arm member 42 follows the first arm member 40 and pivots toward the front side 14 of the container 10 and collapsibly onto the top 52 of the first arm member 40. Such pivotal movement of the arm members 40 and 42 slides the lamp housing 44 into fitting engagement within a substantially cylindrical shelf 54 (also called herein “second recess”) formed slightly just above drawer 30 and adjacent tray beds 24 and 26.

When in its recessed position, the lamp assembly 22 lies substantially flush, or level, with the upper surface 20 of the container 10. In this way, the container 10 itself is compatible for storage in many places which are limited in space, and thus their ability to fit or accommodate certain items. For example, and because of the ability for the lamp assembly 22 to be fully stowed in the manner described above, the container 10 can be stored underneath a bed or within a compartmentalized storage area in a closet or on a workbench. Accordingly, the container 10 is adapted for easy storage in multiple locations which would otherwise prohibit storage of containers which lack its versatility, as described above.

Referring to FIG. 3, the container 10 is seen from its backside 16 and shown in its carrying position in which the handle 18 is deployed to its upright position to enable a user to grab it and carry the container 10 and its contents to a desired location. Also shown is an associated electrical cord 56 which is designed to be plugged into a standard external power outlet (external source of power) in order to receive power to light lamp 23 and to supply power to the container's electrical outlet 34. As shown, the cord 56, in its stowed position, is wrapped around and hung from a hanger 58 located within a recess 60 forming the backside 16 of the container 10.

In a second embodiment, the container 10 includes a rechargeable battery (not shown), which may be removable. The existence of a rechargeable battery may be in place of or in addition to electrical cord 56. With a batter disposed within the container, the user of the container 10 may forego the need and often associated inconvenience of scrambling to find an outlet in which to plug cord 56 to obtain electricity. Since the manufacture, design and usage of a battery within an electrical device is well known, further description thereof is omitted from this description.

It is to be understood that while the discussion herein is applicable to a portable storage container and lamp assembly combination, that such a lamp assembly is contemplated for use with storage containers which are of the stationary variety, and which are otherwise easily adaptable to its construction and integration.

Thus, the present invention is a combination storage container and lamp assembly which advantageously enables its user to avoid the need to carry both a separate lighting device and a separate storage container to a particular location. Additionally, as is appreciated from the above discussion, the combination storage container and lamp assembly of the present invention is sized and shaped similar to a conventional toolbox so as to offer a generous amount of storage space, without compromising the functionality of its lamp assembly. As described above and shown in the figures, the various recesses in the top of the container in which various components of the present invention are stowed advantageously allow for the inclusion of such components within a container without sacrificing storage space or efficiency of usage. Consequently, the user of the aforementioned invention is certain to have ample storage space and a source of lighting for illuminating the particular location to which items stored within the container are transported.

As will be appreciated, such conveniences are particularly attractive to hobbyists and sportsmen such as, for example, crafts makers and fisherman, who have a need to carry many small, individual items which are required for them to enjoy their respective activities.

In summary, the present invention is realized in a portable storage container which is characterized by and may be claimed as a container comprising a plurality of storage members for holding various items; and a lamp assembly operatively connected to the storage members for illuminating an area at which items stored thereby are used in carrying out a task.

Accordingly, there is provided a portable storage container having an included lamp assembly which enables at least each of the advantages described above. Therefore, it is intended that the appended claims be interpreted as including the embodiments described herein, the alternatives mentioned above, and all equivalents thereto.

What is claimed is:

1. A portable storage container, comprising:
an enclosure having front and rear surfaces, a pair of side surfaces, and upper and lower surfaces;
a storage compartment within the enclosure;
a lamp assembly extending from the upper surface of the enclosure, the lamp assembly having an articulating arm pivotally coupled to the upper surface of the enclosure and an elongated lamp housing extending from the articulating arm, the lamp assembly movable between a stowed position and an extended position, the articulating arm and the lamp housing disposed respectively in first and second recesses in the upper surface of the enclosure when the lamp assembly is in the stowed position;
a bulb disposed within the lamp housing; and
a handle pivotally connected to the upper surface of the enclosure.

2. The portable storage container of claim 1, wherein the first and second recesses in the upper surface of the enclosure are perpendicular to one another, the first recess extends along a center of the upper surface, and the second recess extends along a front edge of the upper surface.

3. The portable storage container of claim 1, wherein the articulating arm includes first and second arms pivotally connected to one another, an end of the first arm pivotally coupled to the upper surface of the enclosure and an end of the second arm coupled to the lamp housing.

4. The portable storage container of claim 3, wherein both the first and second arms are disposed on top of one another and within the first recess in the upper surface of the enclosure when the lamp assembly is in the stowed position.

5. The portable storage container of claim 1, wherein both the articulating arm and the lamp housing sit flush with the upper surface of the enclosure when the lamp assembly is in the stowed position.

6. The portable storage container of claim 1, wherein the handle is movable between a stowed position and an extended position, the handle disposed in a third recess in the upper surface of the enclosure when the handle is in the stowed position, the third recess in the upper surface being separate from the first and second recesses.

7. The portable storage container of claim 6, wherein the third recess in the upper surface of the enclosure is disposed around a first end of the first recess, and the second recess is disposed at a second end of the first recess.

8. The portable storage container of claim 1, further comprising a power cord electrically connected to the lamp assembly, the power cord disposed within a recess in the back surface of the enclosure when the power cord is in a stowed position.

9. The portable storage container of claim 8, further comprising a power outlet disposed in one of the surfaces of the enclosure, the power outlet electrically coupled to the power cord and adapted to supply power to an electrical device plugged into the power outlet when the power cord is coupled to an external source of power.

10. The portable storage container of claim 8, further comprising a rechargeable battery disposed within the enclosure and electrically coupled to the power cord and adapted to provide a source of power to the bulb at least when the power cord is not coupled to an external source of power.

11. The portable storage container of claim 1, further comprising a pair of open trays within the upper surface of the enclosure and disposed on opposite sides of the first recess in the upper surface of the enclosure.

12. The portable storage container of claim 1, wherein the storage compartment includes at least one slidable drawer.

13. The portable storage container of claim 1, wherein the lamp housing extends along substantially an entire length of the upper surface of the enclosure.

14. The portable storage container of claim 1, wherein the bulb disposed within the lamp housing is a longitudinally extending fluorescent type bulb.
